(19) United States
(12) Patent Application Publication
(10) Pub. No.: US 2013/0304897 A1
(43) Pub. Date: Nov. 14, 2013

(54) METHOD AND SYSTEM FOR PROACTIVELY PROVIDING TROUBLESHOOTING INFORMATION

(71) Applicants: Syam S. Suri, Wesley Chapel, FL (US); Subrahmanyeswara R. Nekkalapudi, Wesley Chapel, FL (US); Charles E. Bracy, Montclair, NJ (US)

(72) Inventors: Syam S. Suri, Wesley Chapel, FL (US); Subrahmanyeswara R. Nekkalapudi, Wesley Chapel, FL (US); Charles E. Bracy, Montclair, NJ (US)

(73) Assignee: Verizon Patent and Licensing Inc., Basking Ridge, NJ (US)

(21) Appl. No.: 13/466,594

(22) Filed: May 8, 2012

(51) Int. Cl. G06F 15/173

(52) U.S. Cl. 709/224

(57) ABSTRACT

An approach is provided for collecting a plurality of life cycle events relating to one or more customer premise devices associated with a user account, the user account, or the combination thereof, analyzing the plurality of life cycle events to determine a potential service issue with the one or more customer premise devices, the user account, or the combination thereof, and generating a notification based on the analysis to proactively provide troubleshooting to resolve the potential service issue.

### BACKGROUND INFORMATION

Despite the advancements made by service providers towards offering services that simplify complicated tasks, the area of troubleshooting issues associated with such services has not seen similar advancements. Customers often are responsible for determining whether an issue exists and subsequently determining what methods to take to correct such issues. Particularly when issues occur with customer premise devices, such issues may go unnoticed until the customer brings the issues to the attention of the service provider. Additionally, as the number and type of services increase, the number of knowledge bases available to determine methods to correct issues also increases. Further, the area of customer service is playing a more important role in distinguishing service providers. As such, service providers face significant technical challenges in providing technical support to customers in a proactive manner while limiting the additional resources and expenses required for implementing such support.

Based on the foregoing, there is a need for providing proactive troubleshooting of potential service issues associated with customer premise devices based on an analysis of life cycle events.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing proactive troubleshooting of potential service issues, according to an exemplary embodiment;

FIG. 2 is a diagram of a predictive help platform capable of providing proactive troubleshooting of potential service issues, according to an exemplary embodiment;

FIG. 3 is a flowchart of a method for providing proactive troubleshooting of potential service issues associated with customer premise devices based on an analysis of life cycle events, according to an exemplary embodiment;

FIG. 4 is a flowchart of a method for providing proactive troubleshooting of potential service issues associated with a service information change, according to an exemplary embodiment;

FIG. 5 is a flowchart of a method for providing proactive troubleshooting of potential service issues associated with a group of user accounts, according to an exemplary embodiment;

FIGS. 6A and 6B are diagrams of user interfaces used in the processes of FIGS. 3-5, according to exemplary embodiments;

FIG. 7 is a diagram of a computer system that can be used to implement various exemplary embodiments; and

FIG. 8 is a diagram of a chip set that can be used to implement various exemplary embodiments.

### DESCRIPTION OF THE PREFERRED EMBODIMENT

An apparatus, method, and software for providing proactive troubleshooting of potential service issues are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

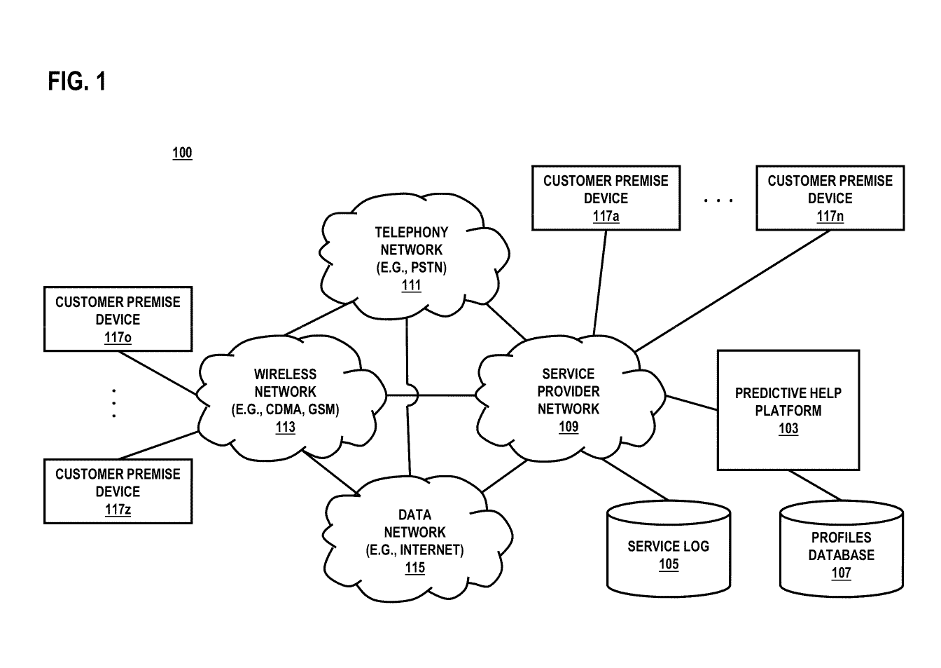

FIG. 1 is a diagram of a system capable of providing proactive troubleshooting of potential service issues, according to an exemplary embodiment. As discussed above, providing troubleshooting for issues associated with services is an important feature for service providers. However, the area has experienced little to no advancements while the services provided have advanced. Issues that customers experience associated with the services, particularly issues associated with specific customer premise devices, often are unnoticed or not acted upon by the service provider. Thus, the customers are left having to troubleshoot the issues themselves. Although service providers have developed knowledge bases for customers to provide support for potential issues, the customers are still required to diagnose the particular issue and find the appropriate knowledge base to correct the issue. With the increased number and complexity of services, even diagnosing the issue includes challenges for the customer. Further, although active monitoring of the services may provide an avenue for service providers to detect potential service issues, the resources and expense required to implement active monitoring of the services is prohibitively large.

The approach of the system 100 stems, in part, from the recognition that service providers passively collect log information associated with services, user accounts, and customer premise devices that may be analyzed to determine potential service issues to provide proactive troubleshooting of the issues to the users. By analyzing log information, service providers may detect potential service issues without requiring the resources associated with active monitoring. Further, by providing proactive troubleshooting information upon the detection of potential service issues, service providers can direct customers to the appropriate knowledge bases to provide information or additional resources to allow the customer to correct the issues or prevent the potential service issues from occurring. Such proactive troubleshooting may be provided to the customers within notifications that may be embedded within the services already provided, thereby not requiring a large amount of additional resources. As service providers continue providing additional services, services providers may include all of the services to provide the notification thereby increasing the likelihood of the customers receiving the proactive troubleshooting information and/or delivering the proactive troubleshooting information over a service that is unaffected by the issue.

As shown, the system 100 includes a predictive help platform 103 implemented as, for example, part of a service provider network 109 for providing proactive troubleshooting of potential service issues. In alternative embodiments, the predictive help platform 103 may be implemented as any part of the system 100. The service provider network 109 can interact with one or more other networks, such as a telephony network 111, a wireless network 113, and/or a data network 115. Associated with the predictive help platform 103 is a profiles database 107. The profiles database 107 may contain profiles (e.g., user accounts) associated with the customers of the service provider network 109. In one embodiment, the profiles database 107 also may contain profiles (e.g., user accounts) associated with customers of the telephony network 111, the wireless network 113, and the data network 115. In one embodiment the service provider network 109, the telephony network 111, the wireless network 113, and the data network 115 can all be associated with individual profiles databases 107a-107d (not shown) that communicate with the predictive help platform 103. In one embodiment, for example, where the same entity controls the service provider network 109, the telephony network 111, the wireless network 113, and the data network 115, the profiles database 107 may contain profiles (e.g., user accounts) associated with one or more of the four networks 109-115.

The service provider network 109 may also utilize a service log 105. The service log 105 may contain log information associated with the services provided by the service provider network 109. In one embodiment, for example, where the same entity controls the service provider network 109, the telephony network 111, the wireless network 113, and the data network 115, the service log 105 may contain log information associated with one or more of the four networks 109-115. In one embodiment the service provider network 109, the telephony network 111, the wireless network 113, and the data network 115 can all be associated with separate service logs 105a-105d (not shown) that communicate with the predictive help platform 103.

In one embodiment, one or more customer premise devices 117a-117n may be associated with the service provider network 109. By way of example, where the service provider network 109 provides television services, the customer premise devices 117a-117n may include, for example, one or more televisions and/or one or more set-top boxes. Where the service provider network 109 provides customers with a connection to the data network 115 (e.g., the Internet), the customer premise devices 117a-117n may include one or more computers, one or more laptops, one or more smart phones, etc. In one embodiment, where the predictive help platform 103 is associated with the wireless network 113, one or more customer premise devices 117o-117z may include, for example, a cellular phone, a radiophone, a satellite phone, a smart phone, etc. For purposes of convenience, customer premise devices 117a-117z are hereinafter referred to as customer premise devices 117.

For illustrative purposes, the networks 109-115 may be any suitable wireline and/or wireless network, and be managed by one or more service providers. For example, the telephony network 111 may include a circuit-switched network, such as the public switched telephone network (PSTN), an integrated services digital network (ISDN), a private branch exchange (PBX), or other like network. The wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, the data network 115 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, the networks 109-115 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that the networks 109-115 may include components and facilities to provide for signaling and/or bearer communications between the various components or facilities of system 100. In this manner, the networks 109-115 may embody or include portions of a signaling system 7 (SS7) network, or other suitable infrastructure to support control and signaling functions.

According to exemplary embodiments, end user devices may be utilized to communicate over system 100 and may include any customer premise devices 117a-117o capable of sending and/or receiving information over one or more of the networks 109-115. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

By way of example, the components and devices of the system 100 may communicate with each other using well known, new or still developing protocols. In this context, a protocol includes a set of rules defining how the network nodes within the system 100 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the system 100 collects a multitude of life cycle events associated with one or more customer premise devices 117 associated with a user account. The life cycle events may include any event information associated with the customer premise devices 117 that is logged at the service log 105. By way of example, life cycle events may include the date and/or time when customer premise devices 117 turn on or turn off, the date and/or time when the customer premise devices 117 are used, information regarding the usage, and error information associated potential issues. By way of a specific example, a life cycle event may be associated with an error message generated by a customer premise device 117a in the event of a hardware failure. Life cycle events also may be associated with user accounts and not tied to a specific customer premise. By way of example, a life cycle event may be associated with a television service provider attempting to provision one or more additional channels to the user account. Whether the provisioning is successful may be logged as a life cycle event at the service log 105. By way of an additional example, a life cycle event may be the triggering of a warning indicating that a credit card associated with a user account is about to expire or that a bill is overdue that are logged at the service log 105 and associated with the user account.

Based on the collection of life cycle events associated with customer premise devices 117 and/or user accounts, the predictive help platform 103 may analyze the life cycle events to determine a potential service issue associated with the customer premise devices 117 and/or the user accounts. After determining the potential service issue, the predictive help platform 103 may generate a notification that is specific to the potential service issue and that provides troubleshooting to resolve the potential service issue. Such troubleshooting may include, for example, directing customers to specific knowledge bases that include information pertaining to correcting the issue, providing contact channels to reach technical support specialists, and individualized routing methods related to, for example, call centers to provide faster support for the particular issue the customer is facing. The predictive help platform 103 may provide the troubleshooting prior to the customer associated with the customer premise device 117a or the user account initiating any effort to correct the potential service issue, and even prior to the customer becoming aware of the potential service issue. Thus, the predictive help platform 103 may proactively provide the troubleshooting prior to any involvement by the customer related to detecting the potential service issue or correcting the potential service issue.

In one embodiment, the predictive help platform 103 may determine a service information change associated with a user account. The service information change may be included as log information stored in the service log 105. Thus, the predictive help platform 103 may determine the service information change based on an analysis of the service log 105. The service information change may be any type of change in the services associated with a user account. As discussed above, by way of example, where the service provider is associated with providing television services, a service information change may be associated with provisioning a new channel at a set-top box associated with a user account. Further, by way of example, where the service provider is associated with providing cellular communications, the service information change may be provisioning support of SMS messages at a customer premise device (e.g., a cellular phone) associated with the user account.

After determining the service information change, the predictive help platform 103 may correlate one or more life cycle events with the service information change to determine a potential service issue. By way of example, the service log 105 may contain log information indicating an order to provision a set-top box associated with a user account with a new channel. The service log 105 also may contain log information associated with one or more life cycle events associated with the set-top box indicating that the provisioning was unsuccessful. For example, the set-top box may log an attempt to view the new channel that was denied because the channel was not properly provisioned at the set-top box. By correlating the life cycle events with the service information change, the predictive help platform 103 may determine that there is a potential service issue associated with the user account, and particularly with the set-top box. The predictive help platform 103 may then provide proactive troubleshooting associated with the service information change, as discussed above.

Where the potential service issue and the service information change are associated with a specific customer premise device, the notification generated by the predictive help platform 103 may be based on the specific customer premise device. By way of example, a notification may indicate by a serial number, a model number, a customer-designated name, etc. the set-top box that was not provisioned with a channel based on a requested service information change. Accordingly, when the customer receives the notification, the notification particularly designates the affected customer premise device and educates the customer regarding the potential service issue and provides troubleshooting for how to correct the issue.

In one embodiment, the potential service issue may be determined based on a number of similar entries within the log information at the service log 105. By way of example, the log information stored in the service log 105 may include information pertaining to repeated failed attempts to perform an action, such as repeated failed attempts to log into an e-mail account. Often, customers may mistakenly enter an incorrect username and/or or password when attempting to login to the e-mail account. Thus, one invalid attempt to login into an e-mail account may be disregarded. However, when the log information includes, for example, repeated attempts to login using the same username with different passwords, or using various usernames from the same Internet Protocol (IP) address, the repeated, similar attempts may indicate a potential service issue. Accordingly, the predictive help platform 103 may determine potential service issues based on a number of similar entries in the log information.

Upon generating the notification, the predictive help platform 103 may initiate a transmission of the notification to a customer premise device when the customer premise device accesses one or more communication channels associated with the service provider. By way of example, where the provisioning of a channel at a set-top box fails because the set-top box was, for example, off during the service provider's attempt to provision the channel, upon the set-top box turning on and accessing the communication channel of the service provider to receive television services, the predictive help platform 103 may initiate a transmission of the notification over the communication channel to the set-top box to proactively provide troubleshooting to the customer of the set-top box regarding how to correct the service issue.

In one embodiment, a service provider may include more than one communication channel that customer premise devices may access. By way of example, service providers may provide television services, Internet services, and telephony services. When a potential service issue exists associated with, for example, the television services, a customer may attempt to access the service provider through telephony services by, for example, dialing into a technical support call center. Although the customer is not using the customer premise device associated with the potential service issue to access the communication channel associated with the service provider, the predictive help platform 103 may determine an association between the telephony customer premise device and a user account, and determine that the user account is also associated with the customer premise device that is experiencing the potential service issue. By way of example, the account number associated with the television services may be correlated to the user account, and the user account may be correlated to the telephone number used to dial into the call center. Accordingly, the predictive help platform 103 may initiate the transmission of the notification to the telephony customer premise device instead of the customer premise device affected by the potential service issue (e.g., the set-top box).

In one embodiment, the predictive help platform 103 provides a link in the notification specifying one or more troubleshooting knowledge bases specific to the potential service issue. The customer may then select the link and be provided with additional troubleshooting information specific to the potential service issue. In one embodiment, the link may be in the form of an initial selection, such as an initial selection in response to dialing into a call center. For example, a customer may dial into a call center to receive troubleshooting. Rather than having to navigate through various initial options to determine why the customer is calling, the predictive help platform 103 may issue a notification, such as questioning whether the customer is calling into the call center for the detected potential service issue, and provide the first selection (e.g., pressing the 1 button) as the link to receive more information specific to the potential service issue.

As discussed above, the predictive help platform 103 may determine a user account associated with a potential service issue. The predictive help platform 103 may further determine a group of user accounts that are associated with the user account. The predictive help platform 103 may determine the group of associated user accounts based on, for example, one or more life cycle events, one or more customer premise devices, a service information change, a service area, a geographic area, or a combination thereof that are associated with both the user account associated with the potential service issue and the group of associated user accounts. By way of example, an issue may arise associated with a service area of a service provider. Accordingly, all user accounts associated with the service area should all be affected by the same potential service issue. Thus, the determination of one potential service issue associated with a user account that is traceable to a service area may be associated with the group of user accounts associated with the service area. Similarly, a user account may be associated with a customer premise device that has a potential service issue. The potential service issue may be the result of a hardware defect specific to the particular customer premise device. Thus, other user accounts that are associated with the same particular customer premise device (e.g., same model number, etc.) may also suffer from the same hardware defect and therefore be associated with the user account originally determined to have a potential service issue related to the particular type of customer premise device.

Accordingly, based on the determination of the group of associated user accounts, the predictive help platform 103 may initiate the transmission of the notification to the user accounts of the group of associated user accounts when one or more customer premise devices associated with the associated user accounts access one or more communication channels associated with the service provider. Thus, based on a potential service issue associated with one user account, other associated user accounts may receive the same proactive troubleshooting information to help resolve any potential service issue that the group of associated user accounts may encounter.

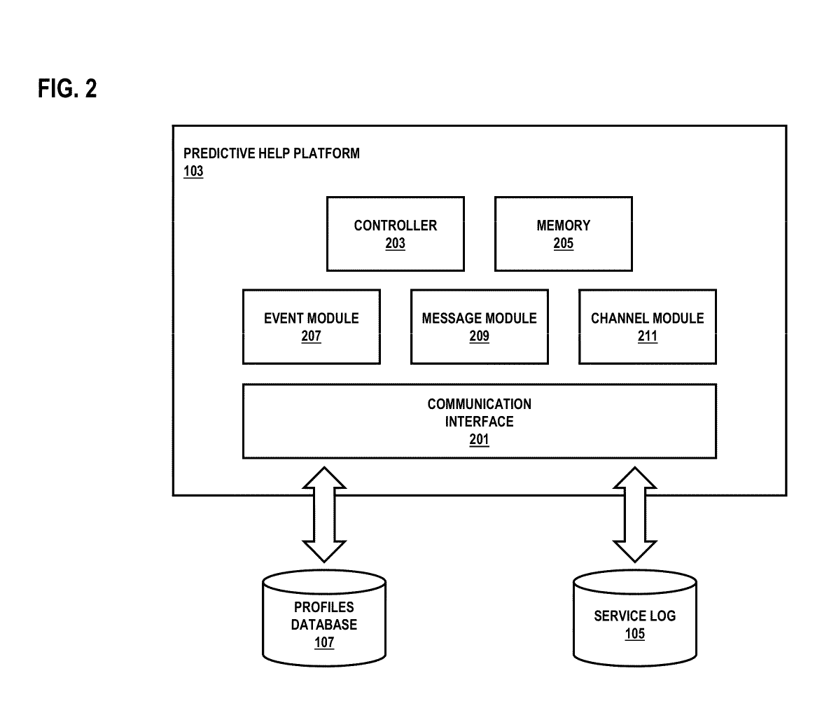

FIG. 2 is a diagram of the predictive help platform 103 capable of providing proactive troubleshooting of potential service issues, according to an exemplary embodiment. In one embodiment, the predictive help platform 103 includes a communication interface 201, a controller 203, memory 205, an event module 207, a message module 209, and a channel module 211.

Communications between the predictive help platform 103 and other components of the system 100 (e.g., the service log 105, the profiles database 107, etc.) are effectuated by the communication interface 201. The communication interface 201 may handle various well known, new or still developing protocols, as discussed above. In one embodiment, the communication interface 201 may handle multiple protocols simultaneously and convert between protocols to provide compatibility with multiple different components and devices of the system 100.

The predictive help platform 103 may also include one or more controllers (or processors) 203 for effectuating the features and functionality of the predictive help platform 103, as well as one or more memories 205 for permanent and/or temporary storage of one or more variables, parameters, information, signals, etc. used in effectuating the functionality of the predictive help platform 103. In this manner, the features and functionalities of the predictive help platform 103 may be executed by controller(s) 203 and/or memories 205, such as in conjunction with one or more of the various components of the predictive help platform 103.

The event module 207 interfaces with the service log 105 and the profiles database 107 to analyze the collected life cycle events associated with the customer premise devices 117 and the user accounts. The event module 207 also analyzes the log information stored in the service log 105 to determine service information changes associated with user accounts. The event module 207 correlates life cycle events to determine potential service issues with one or more customer premise devices, and may further correlate the life cycle events with the service information changes to determine potential service issues. In one embodiment, the event module 207 determines a potential service issue based on a number of similar entries associated with the log information.

In one embodiment, the event module 207 analyzes life cycle events, customer premise devices, service information changes, user accounts associated with a service area, user accounts associated with a geographic area, or a combination thereof to determine a group of user accounts that are associated with a specific user account that may be associated with a potential service issue. For example, the event module 207 may have previously determined a potential service issue associated with the specific user account. By determining a group of user accounts that are associated with the specific user account based on any one or more of the above factors, the event module 207 may determine other user accounts that may also be associated with the same potential service issue. Accordingly, similar notifications may be provided to the group of user accounts upon customer premise devices associated with the group of user accounts access one or more communication channels associated with a service provider.

In part because the event module 207 analyzes log information stored in the service log 105, the predictive help platform 103 is able to passively monitor services of service providers to provide proactive troubleshooting in response to potential service issues without requiring the resources associated with an active monitoring system.

The message module 209 generates one or more notifications based on the analysis provided by the event module 207 for troubleshooting the potential service issue. The notifications may contain information such as, for example, specific knowledge bases that the customers may access to obtain additional information to correct the potential service issue. In one embodiment, the notifications may include one or more links that direct the customer to the specific knowledge base. By way of example, a notification may contain a link that causes a browser to access a webpage that includes frequently asked questions, the link may be an audio recording that provides options to receive additional information specific to a potential service issue, etc. By interfacing with the event module 207, the message module 209 may provide information within the notification that is specific to the customer premise device that is associated with the potential service issue. In one embodiment, the message module 209 generates the notification in response to a detection of the potential service issue and stores the notification correlated to the user account and/or the customer premise device in the profiles database 107. In one embodiment, only after a user account and/or a customer premise device accesses a communication channel does the message module 209 generate the notification.

The channel module 211 monitors the various communication channels associated with service providers that a user account and/or a customer premise device may access. In one embodiment, upon determining that a user account and/or a customer premise device accessed a communication channel, the channel module 211 interfaces with the event module 207 to determine whether the user account and/or the customer premise device is associated with a potential service issue. For example, in response to a detection of a potential service issue, the event module 207 will correlate the potential service issue with the user account stored in the profiles database 107. Thus, when the channel module 211 determines a user account and/or a customer premise device associated with a user account accesses a communication channel, the channel module 211 may interface with the event module 207 and/or the profiles database 107 to determine if there is a potential service issue associated with the user account. When there is a potential service issue, the channel module 211 will interface with the message module 209 to initiate the transmission of a notification to proactively provide troubleshooting information to resolve the potential service issue.

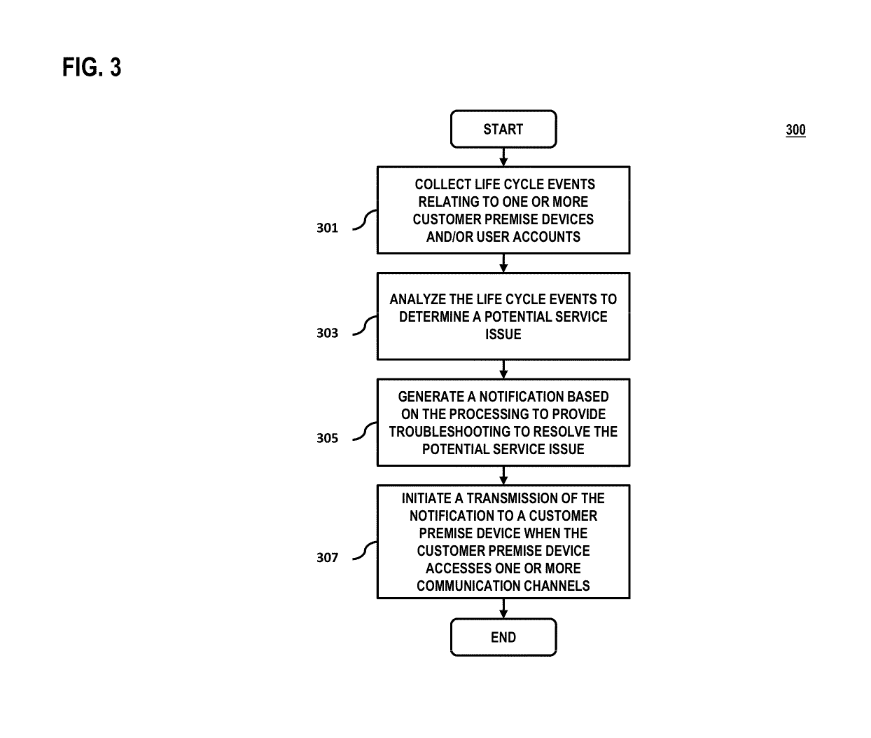

FIG. 3 is a flowchart of a method for providing proactive troubleshooting of potential service issues associated with customer premise devices based on an analysis of life cycle events, according to an exemplary embodiment, that may be carried out by an embodiment illustrated in, for example, FIG. 2. In step 301, the system 100 is configured to collect log information associated with the various components within the service log 105. As discussed above, the customer premise devices 117 may generate log information that is stored in the service log 105. Further, one or more of the networks 109-115 may generate log information pertaining to, for example, service information changes that is stored in the service log 105. As discussed above, the log information is passively collected. The predictive help platform 103 collects or loads the log information stored in the service log 105 to process the information for determining potential service issues. In one embodiment, the predictive help platform 103 may continuously monitor and load the log information from the service log 105 for processing. In one embodiment, the predictive help platform 103 may periodically or on demand monitor and load the log information for processing.

In step 303, the predictive help platform 103 analyzes the life cycle events to determine a potential service issue associated with a customer premise device and/or a user account. As discussed above, a potential service issue may include a wide variety of issues, such as the failure to correctly provision a service at a customer premise device, a hardware failure associated with a customer premise device, repeated, failed login attempts associated with a user account, a service promotion expiration, service disconnection and/or suspension, overdue payments, etc. Accordingly, the potential service issue may correspond to any subject or issue that may arise associated with one or more services provided to the customer.

In step 305, the predictive help platform 103 generates a notification based on the determined potential service issue to provide troubleshooting to resolve the potential service issue. The notification may be any type of notification, such as an audio notification and/or a visual indication. The notification may alert the customer of the potential service issue and provide troubleshooting information specific to how to correct the issue. The notification may include one or more links that direct the customer to, for example, specific knowledge bases that address the issue, certain communication channels (e.g., technical call centers) that provide additional assistance in correcting the issue, etc. By way of example, if the potential service issue concerns the disruption of service based on lack of payment, the link may include a method of effectuating payment, such as a number to call to make the payment over the phone, or a website to visit to make a payment electronically.

In step 307, the predictive help platform 103 initiates a transmission of the notification to a customer premise device when the customer premise device accesses one or more communication channels. A communication channel corresponds to any method or channel by which a communication (e.g., audio and/or visual communication) may be sent by the service provider (or a third party for the service provider) to a customer premise device. In one embodiment, the initiation occurs when the customer premise device that is associated with the potential service issue accesses a communication channel. By way of example, a customer may use a computer to access email provided by the service provider. Based on repeated, failed attempts to login to the email account, when the computer next accesses the communication channel by which the service provider provides email (e.g., through the Internet), the predictive help platform 103 may initiate transmission of the notification concerning the repeated, failed attempts to login to the email account (e.g., troubleshooting associated with re-setting a password, etc.). In one embodiment, the initiation occurs when another customer premise device that is associated with the potential service issue by, for example, association with the user account that is associated with the issue (either directly or through a different customer premise device) accesses a communication channel. By way of example, a potential service issue may be associated with a computer. Where the service provider provides both Internet services and television services, when the set-top box accesses the communication channel associated with television services, the predictive help platform 103 may initiate transmission of the notification concerning the computer to the set-top box for display. Thus, where a single service provider provides multiple services to a customer, communication channels associated with any one of the services may be used to transmit the notification to the customer concerning a potential service issue using any one of the associated customer premise devices. Accordingly, by providing the notification to a customer premise device when the customer premise device accesses one or more communication channels, the predictive help platform 103 allows for the proactive provisioning of troubleshooting to resolve potential service issues based solely on customer premise devices accessing the communication channels, which may not require the customer to perform any action to receive the support. Thus, issues that may arise may be prevented before they even occur, or customers can receive individualized support based on their specific needs to correct issues that occur without having to first determine what the issue is, and then determine the method or route needed to correct the issue

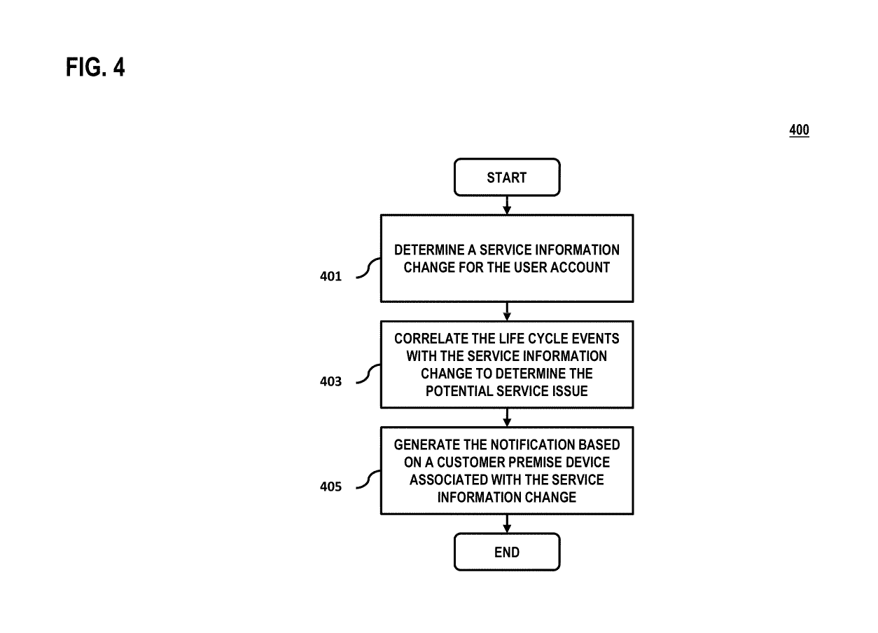

FIG. 4 is a flowchart of a method for providing proactive troubleshooting of potential service issues associated with a service information change, according to an exemplary embodiment, that may be carried out by an embodiment illustrated in, for example, FIG. 2. As discussed above, potential service issues may be associated with service information changes. Such log information associated with the service information changes are stored in the service log 105. In step 401, the predictive help platform 103 determine a service information change associated with a user account. The predictive help platform 103 may determine the change by continuously, periodically, or on-demand monitoring or collecting log information from the service log 105 associated with service information changes. In one embodiment, the log information may explicitly indicate what log information constitutes service information changes. In one embodiment, the predictive help platform 103 may analyze the log information to determine what log information constitutes service information changes.

In step 403, the predictive help platform 103 correlates life cycle events associated with customer premise devices and/or user accounts with the service information changes to determine potential service issues. By way of example, a service information change may correspond to the provisioning of a channel at a set-top box. The service log 105 may include one or more entries indicating the request to have the channel provisioned at the set-top box. However, one or more life cycle events associated with the set-top box, such as an indication that the set-top box was offline at the time of provisioning, or a routine synchronization of the channels supported by the set-top box may indicate that the provisioning was unsuccessful. By correlating the service information change with the life cycle events, the predictive help platform 103 is able to determine one or more potential service issues.

After determining the potential service issues, at step 405, the predictive help platform 103 generates the notification to provide proactive troubleshooting to resolve the potential service issue, as discussed above. In one embodiment, the predictive help platform 103 may generate the notification based on the customer premise device associated with the service information change. By way of example, where the service information change is associated with provisioning SMS capability at a cellular phone, the notification may indicate the cellular phone that is affected and/or may be sent to the cellular phone that is affected.

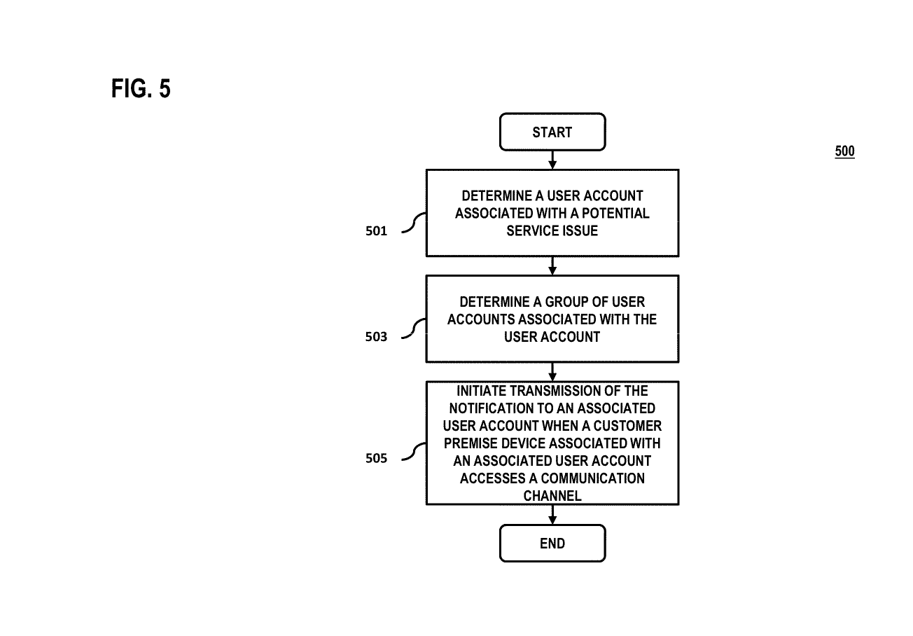

FIG. 5 is a flowchart of a method for providing proactive troubleshooting of potential service issues associated with a group of user accounts, according to an exemplary embodiment, that may be carried out by an embodiment illustrated in, for example, FIG. 2. In step 501, the predictive help platform 103 determines a user account that is associated with a potential service issue based on the discussion above.

Next, in step 503, the predictive help platform 103 may determine a group of user accounts that are associated with the user account that was determined to have a potential service issue. The group of associated user accounts may be associated with the user account based on any one or more of, for example, one or more life cycle events, one or more customer premise devices, a service information change, a service area, and a geographic area. By way of example, a group of user accounts may share similar life cycle events that were determined to be associated with a potential service issue, a group of user accounts may share similar customer premise devices that were determined to have hardware errors that resulted in potential service issues, a group of user accounts may share the same service area and/or geographic area, etc.

Next, in step 505, the predictive help platform 103 initiates the transmission of the notification that was generated based on the original user account and the potential service issue associated with the original user account to one or more of the user accounts associated with the group when a customer premise device associated with the one or more user accounts access a communication channel associated with the service provider. Thus, despite a potential service issue not being detected explicitly for each one of the user accounts associated with the group of user accounts, the notification may be provided to the group of user accounts based on the association with the user account that originally experienced the potential service issue.

By way of example, user account A is associated with a customer premise device of model X1. User account B is also associated with a customer premise device of model X1. Based on an analysis of life cycle events associated with the customer premise device associated with user account A, the predictive help platform 103 may determine a potential service issue that is, for example, related to a hardware failure with customer premise devices of model X1. Because user account B also is associated with a customer premise device of model X1, the predictive help platform 103 may determine that user account B is part of a group that is associated with user account A. Accordingly, when a customer premise device associated with user account B (e.g., the customer premise device of model X1, or any other customer premise device associated with user account B) accesses a communication channel associated with the service provider, the predictive help platform 103 may provide the same (or similar) notification to user account B regarding the potential for a hardware fault of the customer premise device. Thus the notification to user account B may be the same as the notification sent to user account A upon the initial detection of the potential service issue. Accordingly, the predictive help platform 103 may provide proactive troubleshooting information prior to a customer even when a potential service issue is not determined to be linked directly to the customer by way of a user account or customer premise device, but instead based on an association with another user account.

In one embodiment, the notification sent to the one or more user accounts associated with the group of user accounts may be modified according to any differences that exist between the various user accounts, while maintaining the troubleshooting information related to the original potential service issue. Thus, the predictive help platform 103 may account for differences in, for example, one or more life cycle events, one or more customer premise devices, a service information change, a service area, and a geographic area while maintaining the troubleshooting information of the original notification based on the potential service issue.

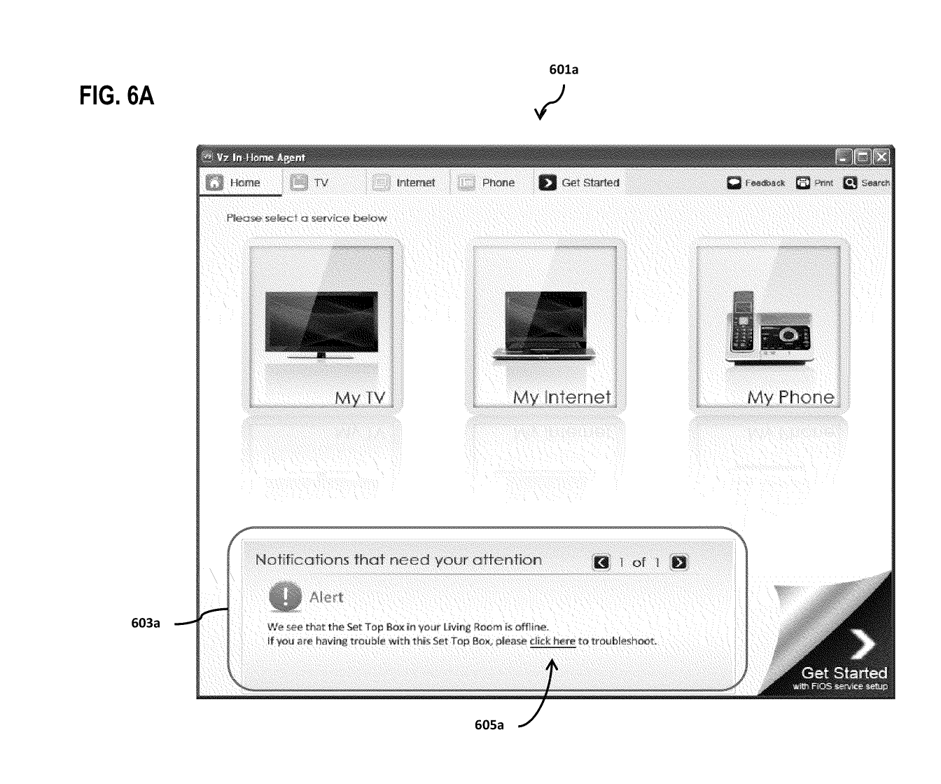

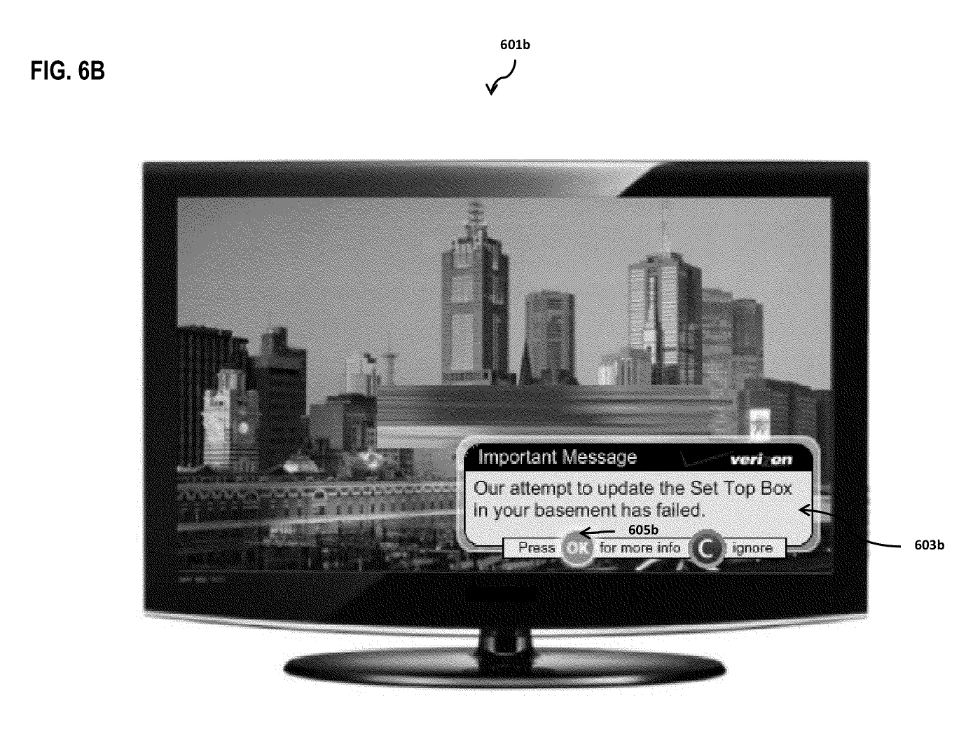

FIGS. 6A and 6B are diagrams of user interfaces used in the processes of FIGS. 3-5, according to exemplary embodiments. FIG. 6A illustrates the user interface 601 a that may be associated with a customer premise device 117a that accesses the data network 115 through the service provider network 109, such as a computer. The user interface 601a may be specifically related to an application running on the customer premise device 117a that is provided by the service provider of the service provider network 109 as a channel for providing communications to the user of the customer premise device from the predictive help platform 103. Indicator 603a illustrates an exemplary embodiment of a notification that was generated in response to the predictive help platform 103 determining a potential service issue associated with the customer premise device 117a and/or the user account associated with the customer premise device. As illustrated, the indicator 603a concerns a potential service issue associated with a set-top box (e.g., a customer premise device 117b other than the customer premise device associated with the user interface 601a). For example, a life cycle event of the set-top box turning off may have triggered the determination of a potential service issue. In addition to the troubleshooting information that provides an indication of a potential service issue and the customer premise device that is affected, the indicator 603a may include a link 605a that the user may select to be routed to additional troubleshooting information for resolving the issue associated with the set-top box.

FIG. 6B illustrates the user interface 601b that may be associated with a customer premise device 117b that accesses the service provider network 109 for television services, such as a television. The user interface 601a may include the general television service (e.g., audio/video associated with a television station) and may include an indicator 603b provided by the predictive help platform 103 that is overlaid the general television service. Indicator 603b illustrates an exemplary embodiment of a notification that was generated in response to the predictive help platform 103 determining a potential service issue associated with the customer premise device 117b and/or the user account associated with the customer premise device. As illustrated, the indicator 603b concerns a potential service issue associated with a set-top box (which may or may not be associated with the customer premise device 117b associated with the user interface 601b). For example, a life cycle event of the set-top box attempting to synchronize television stations with the service provider may have triggered the determination of a potential service issue. The indicator 603b provides the user of the customer premise device 117b with a proactive indication of the potential service issue and troubleshooting information to resolve the issue. By way of example, the indicator 603b may include a link 605b that the user may select to be routed to additional troubleshooting information for resolving the issue associated with the set-top box.

The processes described herein for item selection based on characteristic matching may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

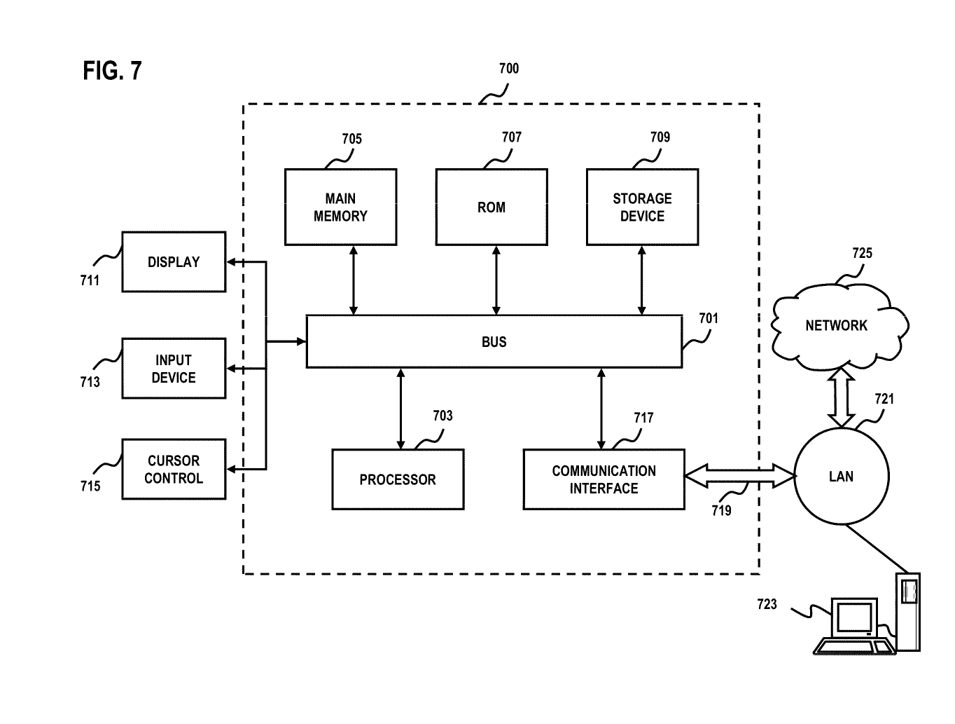

FIG. 7 illustrates computing hardware (e.g., computer system) upon which an embodiment according to the invention can be implemented. The computer system 700 includes a bus 701 or other communication mechanism for communicating information and a processor 703 coupled to the bus 701 for processing information. The computer system 700 also includes main memory 705, such as random access memory (RAM) or other dynamic storage device, coupled to the bus 701 for storing information and instructions to be executed by the processor 703. Main memory 705 also can be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for EthernetTM or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

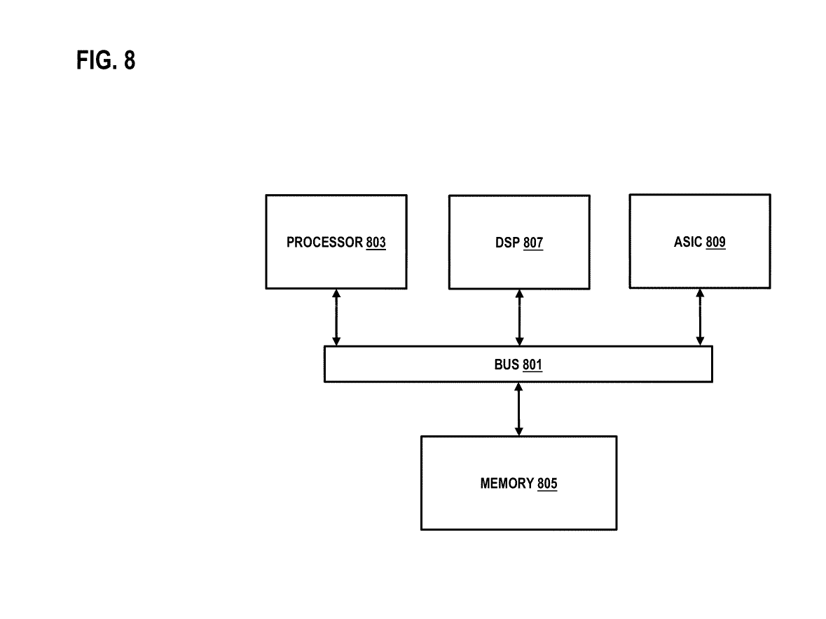

FIG. 8 illustrates a chip set 800 upon which an embodiment of the invention may be implemented. Chip set 800 is programmed to provide proactive troubleshooting as described herein and includes, for instance, the processor and memory components described with respect to FIG. 2 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of FIGS. 3-5.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 805 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
collecting a plurality of life cycle events relating to one or more customer premise devices associated with a user account, the user account, or the combination thereof;
analyzing the plurality of life cycle events to determine a potential service issue with the one or more customer premise devices, the user account, or the combination thereof; and
generating a notification based on the analysis to proactively provide troubleshooting to resolve the potential service issue.

2. A method according to claim 1, further comprising:
determining a service information change for the user account; and
correlating the plurality of life cycle events with the service information change to determine the potential service issue.

3. A method according to claim 2, further comprising:
generating the notification based on a customer premise device associated with the service information change.

4. A method according to claim 1, further comprising:
determining the plurality of life cycle events, the service information change, or the combination thereof based on a passive monitoring of log information.

5. A method according to claim 4, further comprising:
determining the potential service issue based on a number of similar entries associated with the log information.

6. A method according to claim 1, further comprising:
initiating a transmission of the notification to a customer premise device when the customer premise device accesses one or more communication channels.

7. A method according to claim 1, wherein the one or more customer premise devices are maintained by a service provider.

8. A method according to claim 1, further comprising:
providing a link in the notification specifying one or more troubleshooting knowledge bases specific to the potential service issue.

9. A method according to claim 1, further comprising:
determining a group of user accounts associated with the user account; and
initiating a transmission of the notification to one or more associated user accounts when one or more customer premise devices associated with the one or more associated user accounts access one or more communication channels associated with a service provider.

10. A method of claim 9, wherein the group of user accounts are associated with the user account based on one or more life cycle events, one or more customer premise devices, a service information change, a service area, a geographic area, or a combination thereof.

11. An apparatus comprising:
a processor configured to collect a plurality of life cycle events relating to one or more customer premise devices associated with a user account, the user account, or the combination thereof, analyze the plurality of life cycle events to determine a potential service issue with the one or more customer premise devices, the user account, or the combination thereof, and generate a notification based on the analysis to proactively provide troubleshooting to resolve the potential service issue.

12. An apparatus according to claim 11, wherein the processor is further configured to determine a service information change for the user account, and correlate the plurality of life cycle events with the service information change to determine the potential service issue.

13. An apparatus according to claim 12, wherein the processor is further configured to generate the notification based on a customer premise device associated with the service information change.

14. An apparatus according to claim 11, wherein the processor is further configured to determine the plurality of life cycle events, the service information change, or the combination thereof based on a passive monitoring of log information.

15. An apparatus according to claim 14, wherein the processor is further configured to determine the potential service issue based on a number of similar entries associated with the log information.

16. An apparatus according to claim 11, wherein the processor is further configured to initiate the transmission of the notification to a customer premise device when the customer premise device accesses one or more communication channels.

17. An apparatus according to claim 11, wherein the one or more customer premise devices are maintained by a service provider.

18. An apparatus according to claim 11, wherein the processor is further configured to provide a link in the notification specifying one or more troubleshooting knowledge bases specific to the potential service issue.

19. An apparatus according to claim 11, wherein the processor is further configured to determine a group of user accounts associated with the user account, and initiate a transmission of the notification to one or more associated user accounts when one or more customer premise devices associated with the one or more associated user accounts access one or more communication channels associated with a service provider

20. An apparatus according to claim 19, wherein the group of user accounts are associated with the user account based on one or more life cycle events, one or more customer premise devices, a service information change, a service area, a geographic area, or a combination thereof.
